(19) United States
(12) Patent Application Publication
(10) Pub. No.: US 2020/0110476 A1
(43) Pub. Date: Apr. 9, 2020

(54) Digital Redacting Stylus and System

(71) Applicant: Kyocera Document Solutions Inc., Osaka (JP)

(72) Inventor: Gin Yoshidome, San Ramon, CA (US)

(21) Appl. No.: 16/152,416

(22) Filed: Oct. 5, 2018

(51) Int. Cl. G06F 3/0354; G06K 9/34; G06F 17/24; H04N 1/00

(52) U.S. Cl. CPC G06F 3/03545; H04N 1/00384; G06F 17/24; G06K 9/344

(57) ABSTRACT

Digital redacting stylus enabling footprint-less marking of redaction targets on a physical original document, and system involving the stylus and a multifunction peripheral device that uses the unaltered physical original document itself, together with data from the stylus to print out, or otherwise visually represent, an accordingly redacted copy of the physical original document. The stylus can also enable a user to add words, not present in the physical original document, to an OCR-scanned digital copy of the original document that is then printed out or visually represented.

### BACKGROUND

### Technical Field

The present invention relates to processing and electrophotographic printing of image-analysis data obtained from physical documents or facsimiles, and more particularly relates to handling text-data files obtained by scanning and OCR-processing physical documents or facsimiles.

### Description of the Related Art

The ease with which scanned or other facsimile reproductions of physical documents are and can be made available to the public through various online means has given rise to considerable interest in redacting sensitive content in facsimile reproductions of documents. Redacting a physical document—that is, hiding or removing some targeted part or parts of text in the document before printing or otherwise publishing or distributing the document—conventionally has been accomplished by simply blotting out the targeted text with ink or otherwise highlighting it for a later-stage redacting process on the highlighted text. Conventionally in cases where the original physical document should be preserved intact, a redaction-purposed copy of the document must be made for undergoing the redaction process. The physically marked, redaction-purposed copy of the document is then photocopied or scanned as the redacted document for publication or distribution.

Technology has been proposed for redacting electronic documents produced from physical documents, but originally lacking digitally manipulable text. A recently patented example employs optical character recognition (OCR) to detect and represent text entities to be redacted in a “native” digital electronic document. The technology analyzes the text entities from a native document, described as “any stored file that includes text,” and mentioned examples of which are “a word processing document, a spreadsheet, a presentation, a file-based database, a text file, etc.,” and operates on the native document by initially converting it into a “native image document.” The native image document is then separately converted via OCR into text data for isolating the text corresponding to the analyzed text entities. The OCR-data based isolating of the text entities determines “bounding coordinates” that describe the locations of, and “bounding rectangles” drawn around, the text to be redacted. The bounding coordinates serve to map the text entity locations in the OCR text file to the identical locations in the native image document, where the bounding rectangles, which conceal the redacted text, are inscribed.

An older patented technology involves associating a paper document with its digital counterpart. The disclosure of that technology centers on the concept of editorially highlight-marking on a physical document that has a counterpart in electronic form, optically scanning the highlighted sections of the paper document to extract features, and employing the features as queries to query a database such as to locate and retrieve the digital counterpart to the paper document. The technology optionally performs OCR on the highlighted sections to extract the features as highlighted text. The disclosure also purports to identify the locations where the highlighted texts occur within the digital counterpart document or documents, but the only method given for doing so is by byte offsets. Thus, the highlighted texts' locations within the digital counterpart documents presumably would be determined simply by counting alphanumeric characters within each page of the digital counterpart from an origin point on the page, to find the text with the same offset as the highlighted text.

A more recently patented technology by a major Internet services and products company involves a similar concept, a system of “paper/digital integration.” The system takes advantage of the widespread availability, in Internet-accessible or other network-accessible databases, of an electronic counterpart of a paper or other physically rendered document, by likewise utilizing a digitally captured, characteristic portion of the rendered document to retrieve the electronic counterpart and present it in whole or in part, by displaying it, printing it, Webpage-posting it, etc. A text sample captured from the paper or otherwise rendered physical document is employed as an identifier for the physical document and thus as a link to its electronic counterpart. The digital capturing of the identifier text is preferably accomplished by “a graphical capture device,” which can be a handheld scanner, although speech-to-text means are also contemplated. After the counterpart electronic document is retrieved, based on the text sample as captured, or broadened to incorporate surrounding text, carried out on the electronic document are operations including adding markup data—essentially metadata—in the form of static or dynamic annotations to, or overlays on, the text, and using a software application to edit the document. It is suggested that the application annotate or edit the electronic counterpart of a paper document as a human editor electronically scans (digitally captures) various parts of the document.

A very recently patented technology centers on the concept of utilizing the operations-controlling touchscreen on a multifunction peripheral (MFP) or similar photocopying/printing/scanning device to allow a user to make printing-form changes and editorial changes to an electronic document at the device, on the touchscreen. The electronic document is produced by scanning a physical document on the MFP. The editing functions that can be carried out on the MFP device's touchscreen include redacting selected sections of the electronic document, by creating a separate, redacted version on the touchscreen that is then printed out.

No technology has yet been proposed for enabling redaction of a physical original document, without altering the document, and yet using that document to print out an accordingly redacted version of the physical original.

### SUMMARY

A digital redacting stylus includes an imaging module having an image sensor outputting an image data signal representing image information in a scanning target; a processor that by processor-associated memory is especially configured to, inter alia, OCR-process the data signal outputted from the imaging module to convert the data signal into a signal containing text information, and output the text information as words; a redacting-stylus storage that stores as a redactional-word database the text information outputted as words from the especially configured redacting-stylus redaction processor; a press-to-scan button whose switching on/off determines the duration of the scanning operation and thus the length of a given phrase for redaction; and an MFP interface connector in the butt end of the stylus, for data-output communicative connection with a multifunction peripheral device.

A digital redacting system comprises the digital redacting stylus just described, and an MFP, the MFP including a redacting-stylus interface connector for connection with the MFP interface connector in the digital redacting stylus, and processing control circuitry that, with the redacting stylus interface connector being connected with the MFP interface connector, loads the redactional-word database from the redacting stylus into the MFP storage and puts the MFP device into an MFP redaction mode. In the MFP redaction mode, the MFP processing control circuitry, via OCR scanning functionality, OCR-converts a received electronic document, searches the OCR-converted document for words matching the redactional-word database, mark-out redacts all matching words to produce a mark-out-redacted version of the electronic document, and sends out the mark-out-redacted version of the electronic document for printing or other visual representation.

The redacting stylus can be configured by processor-associated memory as an addword processor operating to store addwords input into the associated memory, and add the input addwords to either before or after any word in the redactional-word database, thereby creating an addword-completed database.

A digital inverse-redacting system comprises the just-described digital redacting stylus with the addword processor, and an MFP, the MFP including a redacting-stylus interface connector for connection with the MFP interface connector in the digital redacting stylus, and processing control circuitry that, with the redacting stylus interface connector being connected with the MFP interface connector, loads the addword-completed database from the redacting stylus into the MFP storage and puts the MFP device into an MFP inverse-redaction mode. In the MFP inverse-redaction mode, the MFP processing control circuitry, via OCR scanning functionality, OCR-converts into a text file a received electronic document, compares the text file against the addword-completed database to find text-file words matching any portion of the addword-completed database, when a current text-file word matches some portion of the addword-completed database, checks for any overlap either preceding or following the current text-file word and the matching portion of the addword-completed database, replaces the overlap in the text file with the entirety of the matching portion of the addword-completed database, and sends out the addword-added version of the electronic document for printing or other visual representation.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is a diagrammatic lateral view of a digital redacting stylus of the present disclosure in a representative embodiment;

FIG. 2 is an oblique, rear view of the digital redacting stylus in a see-through rendering illustrating the stylus' internal components;

FIG. 3 is a flowchart illustrating Algorithm One, for creating redaction strings and setting up redactional-word databases with the digital redacting stylus;

FIG. 4 represents a dedicated MFP device for a digital redacting system, a head-on view including the operating interface area of the MFP where equipped with nonfunctional (carrying) and functional (data-transfer) redacting-stylus slot-holders to holster a digital redacting stylus of the present disclosure;

FIG. 5 is a closeup enlargement from FIG. 4, schematically representing a redacting stylus holstered in a slot-holder in the dedicated MFP;

FIG. 6 is a flowchart illustrating Algorithm Two, a redacted-document creation routine;

FIG. 7 is a flowchart illustrating Algorithm Three, a branch routine of an addword processor in an additive embodiment of a digital redacting stylus of the present disclosure; and

FIG. 8 is a flowchart illustrating Algorithm Four, a branch routine in a mode of a digital redacting stylus in certain embodiments termed Inverse-Redaction Mode in the present disclosure.

### DETAILED DESCRIPTION

### Redacting Stylus

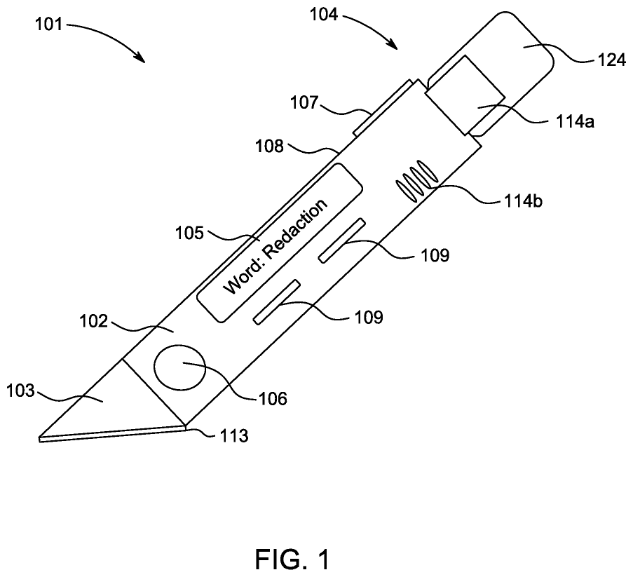

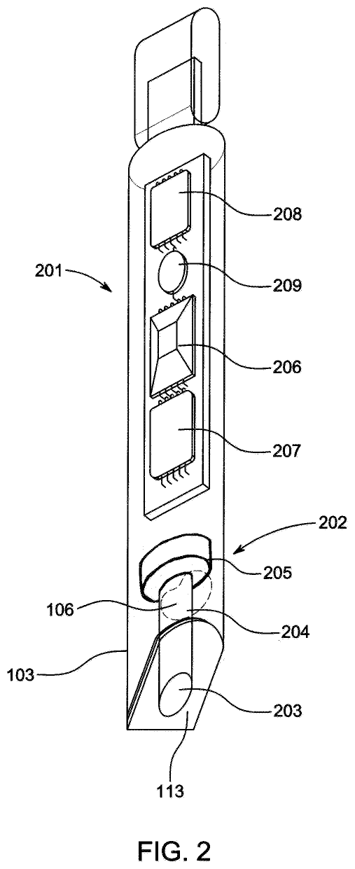

As representatively illustrated in FIGS. 1 and 2, a digital redacting stylus 101 in one embodiment is a handheld device whose electronics 201 are housed in the barrel 102 of an elongate casing. The opposite ends of the casing respectively constitute a scanning tip 103 and a data-output butt 104. The scanning tip 103 is fitted with a transparent scanning plate 113, preferably at an oblique angle with respect to the casing's longitudinal axis. The butt end 104 of the casing is furnished with an MFP interface connector, to enable data-output communicative connection with a multifunction peripheral device. The interface connector may be a universal serial bus (USB) type-A connector 114a, capped by a protective cover 124, or may be a communication node 114b similar to SD™-card interface pins. As is the case with the implementation illustrated in FIG. 1, the redacting stylus 101 may be equipped with both a USB connector 114a and a communication node 114b. The data-output communicative connection with an MFP will be discussed later, in describing a digital redacting system according to the present disclosure.

An imaging module 202 is disposed in the casing tip 103. The imaging module 202 includes an image sensor(s) 203, and optics 204 for receiving light reflected from a scanning target and focusing the reflected light onto the image sensor(s) 203. The reflected light is light from a scanning illumination source 205 with which the imaging module 202 furnished, or it may be ambient light. In the former implementation, the scanning illumination source 205 is disposed in a location on the redacting stylus where the illumination source 205 illuminates the scanning target (physical original document), but not the interior of the redacting-stylus casing. It will be appreciated that the image sensor(s) 203 may be constituted by charge-coupled device (CCD) sensors, complementary metal-oxide semiconductor (CMOS) sensors, or similar optical sensors.

The electronics 201 housed in the barrel 102 of the redacting stylus 101 include a redacting-stylus optical-character-recognition (OCR) processor (“redaction processor” and also “addword processor”—see below under “Inverse-Redaction Mode”—hereinafter) 206, connected to the imaging module 202, and associated memory 207, and a redacting-stylus storage 208 connected to the redacting-stylus redaction processor 206 and associated memory 207. The storage 208 is connected to the MFP interface connector 114a, 114b. The redaction processor's associated memory 207 holds, or loads from the redacting-stylus storage, programming information that especially reconfigures what would otherwise be a general-purpose computer processor to function as special-purpose circuitry constituting a redaction processor 206 operating as described hereinbelow.

The digital redacting stylus 101 also includes, housed in the barrel 102 of the redacting stylus: a display 105 connected to the redaction processor 206, wherein the processor is configured with display-drive control circuitry for visually representing, on the display, OCR-processor generated text information in the redacting stylus' scanning target as redactional words; a power source 209 such as a battery(ies), which may be rechargeable through the earlier-mentioned USB connector 114a as the MFP interface connector, the power source 209 being connected to the imaging module 202, the redaction processor 206 and associated memory 207, the redacting-stylus storage 208, and the display; and a press-to-scan button 106 connected by known means (not shown) to the power source 209, and which may be in the form of a push on/off switch, or a press-and-hold on/release off (i.e., normally open) switch.

It should be understood that the redacting stylus is furnished with a means for switching on the power to the stylus overall, independent of the press-to-scan button. Such means include, but are not limited to, a separate mechanical on/off power switch such as the slide switch 107 representatively illustrated in FIG. 1, a mechanism within the press-to-scan button itself such as, for example, rapidly pressing and releasing the button, similar dual functionality added to, for example, one of the below-described scrolling buttons, or a touch-on/touch-off function in a touchscreen employed for the display. The redacting stylus is preferably provided with a passive or non-emissive display portion 108 that illuminates different fixed text or signs indicating what mode the stylus is in when it is powered on. Further, the illuminating itself of fixed-text/sign may indicate that power to the stylus is on. Modes that may thus be indicated include the below-described Record Mode, Redaction Mode, and Add Mode.

It will be appreciated that the duration of the scanning operation, as determined by the switching on/off of the press-to-scan button, determines the length of a given phrase for redaction. While the redaction processor 206 can distinguish individual words, in cases where a given redaction target consists of plural words, the duration of the scan operation critically determines the length of the phrase, which may be a single word, to be redacted (the redaction string). Hence, in order to display a given redaction string that in the default font size of the display would be longer than the physical width of the display, one conceivable solution is for the display control circuitry to downsize the font such as to display the full redaction string at once. Given display dimension and readable-resolution limitations, however, preferably the display-drive control circuitry enables scrolling display of the redaction string, so that reducing the size of the display font is unnecessary.

In the latter, preferable implementation for the display-drive control circuitry, the redaction stylus is further furnished with a forward-/back-scrolling button(s) 109, connected to the display-drive control circuitry. The forward-/back-scrolling button(s) 109 enable the redaction stylus user to scroll through a redaction string as displayed on the display, as well as to scroll from one redaction string to a succeeding or a previous redaction string.

When the scanning plate 113 on the redacting stylus is placed onto text, which may be hand written as well as printed, in a physical original document and the press-to-scan button is actuated, the imaging module 202 receives reflected light in a pattern passing through the optics 204 and onto the image sensor(s) 203, and the image sensor(s) 203 output an image data signal corresponding to a bitmapped image in the field of view of the scanning plate 113. The redaction processor 206 receives the image data signal outputted from the image sensor(s) 203 in the imaging module 202, and OCR-processes the image data signal to convert it into text and output the text as words. The word from the redaction processor 206 is outputted both to the above-described display and to the redacting-stylus storage 208. As stored in the redacting-stylus storage 208 the output from the redaction processor 206 constitutes a redactional-word database. The redactional-word database comprises at least one redaction string.

### Algorithm One

Although the image-to-text data conversion in the redaction processor 206 is according to known methods, the creation of the redaction strings, and of the redactional-word database that the redaction strings constitute, is through the redaction processor 206 having been especially configured for that purpose.

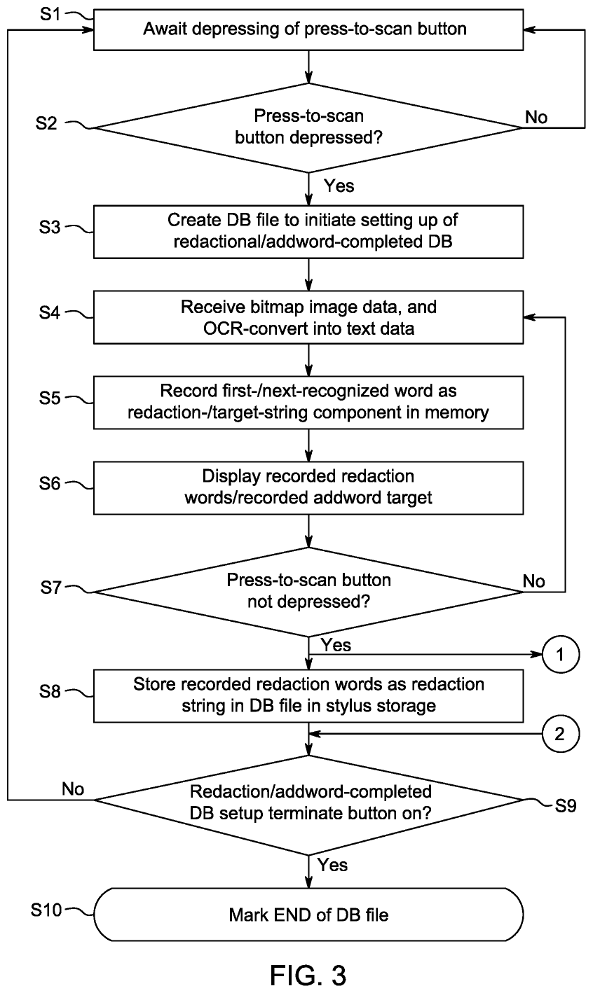

FIG. 3 is a flowchart representing a redaction-string creation and redactional-word database setup process—an algorithmic routine that an especially configured redaction processor 206 of the present disclosure executes. After the redacting-stylus power is turned on the routine begins, Step S1, with the redaction processor 206 waiting for the press-to-scan button to go on (i.e., be pressed). If in Step S2 the redaction processor 206 in a given checking instance at a predetermined clock frequency determines that the press-to-scan button is on, in Step S3 the redaction processor 206 initiates setting up of a redactional-word database by creating a file for the database in the redacting-stylus storage 208, and, in implementations including the aforementioned non-emissive display portion 108, the display indicates that the stylus is in Record Mode.

In some embodiments, the forward-/back-scrolling button(s) 109 together with the redaction processor 206 are enabled for switching the redacting stylus 101 into and out of Record Mode in response to the forward-/back-scrolling button(s) 109 being long-pressed for a predetermined length of time.

In Step S4, the redaction processor 206 receives the bitmapped image data from the imaging module 202, and OCR-converts the image data into text data. In ensuing Step S5, the redaction processor 206 records, in the redaction processor's associated memory 207, the first-recognized word in the text data as the redaction-string start, and any next-recognized word(s) as further elements of the current redaction string. In Step S6, the redaction processor 206 causes the display-drive control circuitry to display the current redaction word(s) on the display. The redaction processor 206 is meanwhile, in Step S7, monitoring for the press-to-scan button to go off, and when the redaction processor 206 recognizes that the button is no longer being pressed, in Step S8, the processor records as the redaction-string end the word last-recognized before the press-to-scan button went off, and stores the thus-recorded redaction word(s) as a completed redaction string in the redacting-stylus storage 208 file for the redactional-word database.

Hence, the duration that the press-to-scan button is on determines the length of the redaction string created during a given scanning instance. It will be appreciated that a given redaction string may be as short as a single word or as long as a multiple word string, limited to a given character length predetermined taking display and scrolling limitations into consideration.

While setting up of a redactional-word database by the redacting stylus is initiated by the redaction processor 206 creating a new file for the database in the redacting-stylus storage 208 when the press-to-scan button begins a given redaction-string creation process, setting up of the redactional-word database is terminated by an operation separate from the starting and stopping of the redacting-stylus scanning operation that produces a redaction string. Terminating the setting up of a redactional-word database by the redaction processor 206 may be by means of a dedicated button (not illustrated) on the redacting stylus 101, separate from the above-described scrolling buttons 109 and the means for turning on the power to the stylus overall, or may be by functionality of the display, in which case the display is a touchscreen, or by functionality added to the scrolling button(s) 109 or to the means for switching on the stylus power, in which case such added functionality may be initiated by, e.g., long-pressing a scrolling button or power switch. Redactional-word database termination signals the redaction processor 206 to mark the end of the file for the database that has been set up.

Thus, after storing the completed redaction string in the redactional-word database file, the redaction processor 206 subsequently determines, in Step S9, whether it has received a signal to terminate the setting up of the redactional-word database. If not, the process flow returns to Step S1 to await pressing of the press-to-scan button. The creation of the redactional-word database continues in this way until the user has completed scanning all the words that the user wishes to redact from a given document. If in Step S9 the redaction processor 206 has received a signal to terminate the setting up of the redactional-word database, it ends the routine, in Step S10, by marking the end of the redactional-word database file.

The redacting-stylus storage 208 thus stores at least a single redactional-word database. The database is output to an MFP device as will be discussed later. In some embodiments, the redaction processor 206 is configured to be triggered by the operation of outputting the database to erase the database from the storage 208, so as to ready the storage 208 for the next redactional-word database creation process. In other embodiments, a copy of the redactional-word database remains in the redacting-stylus storage 208 after a copy is output to the MFP device, to allow a user to add to or modify the database if desired, in which case the redacting stylus has a database-delete function actuated, for example, via the touchscreen in embodiments where the display is a touchscreen, or via a separate, dedicated button switch or the like. In yet an alternative implementation, the afore-described scrolling button(s) 109 may be configured, in conjunction with additional corresponding functionality in the redaction processor 206, to function as multiuse button(s) that enable deleting a given redactional-word database by pressing or otherwise working the button, as well as enable storing a given database within dedicated folders in the storage 208.

### Exemplary Form of Redactional-Word Database

As a specific example, a user uses the redacting stylus on a classified letter in order to scan the personal name “Rackstraw” to be redacted from the text of the letter in an MFP-scanned-and-printed copy of the physical original document. Wishing also to redact the full name “Robert W. Rackstraw” as well as the military unit names “371^{st} Radio Research Unit” and “11^{th} General Support Company” from the letter, the user scans one instance each where each of these terms appears. The redaction processor 206 may store the redactional-word database into the redacting-stylus storage 208 modeled in a simple file format such as JavaScript object notation (JSON). The JSON-scripted redactional-word database would then be as follows. (The braces “{” and “}” at the extreme left margin mark the start and end of the JSON array, i.e., the redactional-word database.)

```
{
    “RedactOne”: {“Robert W. Rackstraw”, “Rackstraw”},
    “RedactTwo”: “371^{st} Radio Research Unit”,
    “RedactThree”: “11^{th} General Support Company”
}
```

### Redacting MFP and System

A multifunction peripheral in accordance with the present disclosure comprises: a scanner/printer, indicated generally by reference numeral 307, with the printer internally including not-illustrated, art-understood printer/photocopier components; an I/O port 308, an operation panel 306 and operation button(s) 303; a below-described redacting-stylus interface for connection with the MFP interface connector 114a, 114b in the digital redacting stylus 101; and below-described MFP storage and processing control circuitry. Via the MFP processing control circuitry, the scanner has optical-character recognition (OCR) functionality, while the MFP processing control circuitry is especially configured to, inter alia, put the MFP into a “Redaction Mode,” as will be detailed later.

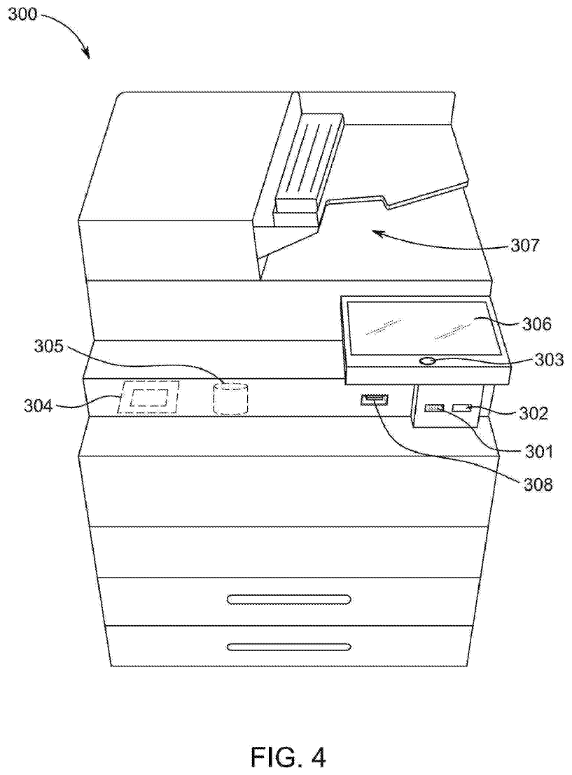

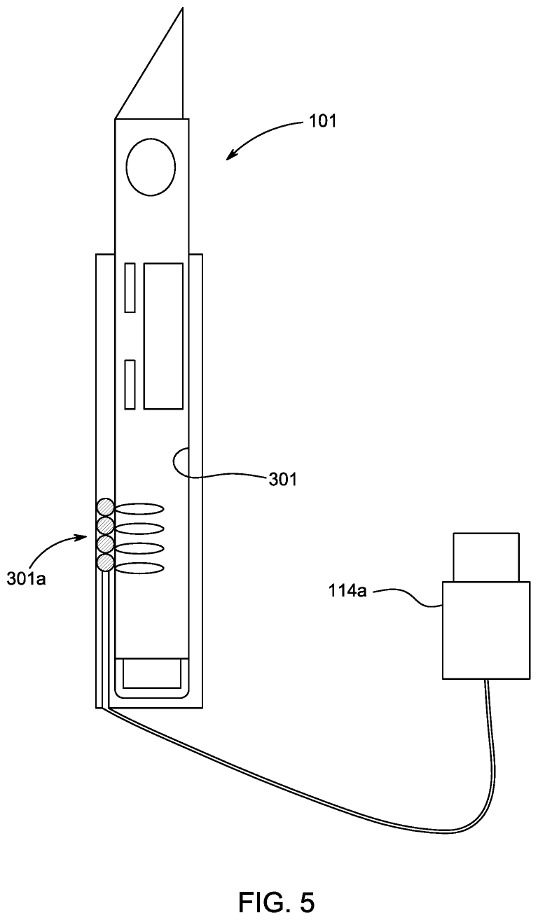

To produce an accordingly redacted copy of the classified letter, the redacting stylus is data-transfer connected with an MFP, thereby setting up a digital redacting system. A digital redacting system according to the present disclosure is made up of a digital redacting stylus 101 as described above, connected to a dedicated MFP device 300, as represented schematically in FIG. 4. The connection is of the redacting stylus's MFP interface connector 114a, 114b into the redacting-stylus interface, in the illustrated implementation a slot-holder 301, furnished in the dedicated MFP 300. In FIG. 4, the slot 302 is optionally provided as simply a holder, having no interface-connecting components or functions. The data-transfer connection between the redacting stylus 101 and the MFP 300 may be wireless, tethered, or mechanical, wherein the form of the connection determines the configuration of the MFP's redacting-stylus interface connector. Wireless connection may be by Bluetooth™; tethered connection may be by USB linkage; and mechanical connection may be by insertion into the slot-holder 301, as detailed in FIG. 5, furnished in the MFP 300. The slot-holder 301 may be built into the MFP 300 when it is manufactured, or the slot-holder may be retrofitted to a previously manufactured MFP. FIG. 5 illustrates an instance in which the redacting stylus 101 is holstered in the slot-holder 301, built into the MFP 300. In FIG. 5, interface pins 301a correspond to the communication node 114b constituting the redacting stylus' 101 interface connector.

Plugging the redacting stylus 101 into the slot-holder 301 in the MFP 300 as illustrated in FIGS. 4 and 5, or otherwise establishing a data-transfer connection between the redacting stylus 101 and the MFP 300 as noted above, triggers the redaction processor 206 to signal the MFP 300 to enter into an MFP “Redaction Mode” in which the MFP 300 receives the redactional-word database. Further, in implementations in which the stylus 101 is furnished with a passive/non-emissive display portion 108, plugging the redacting stylus 101 into the MFP 300 slot-holder 301 (or otherwise establishing the stylus-MFP data-transfer connection) may cause the passive/non-emissive display portion 108 to switch from illuminating fixed text saying “Record Mode” or the like to fixed text saying “Redaction Mode” or the like. At the same time, plugging the redacting stylus 101 into the MFP 300 triggers the redaction processor 206 to send the redactional-word database from the redacting-stylus storage 208 to the MFP device 300.

Specifically, as symbolically indicated in FIG. 4, the MFP 300 is furnished with processing control circuitry 304 and MFP storage 305. The MFP processing control circuitry 304 is configured to load the redactional-word database from the redacting stylus 101 into the MFP storage 305 and put the MFP device 300 into Redaction Mode when the data-transfer connection between the redacting stylus 101 and the MFP 300 is set up. In the MFP storage 305, the redactional-word database is available to the MFP scanner's above-mentioned OCR functionality, for producing, via the MFP photocopier, a redacted copy of the classified letter when the letter is placed on the MFP's scanning/copying platen and scanned for photocopying. A section of the MFP processing control circuitry 304 is configured to provide the OCR functionality.

### Algorithm Two

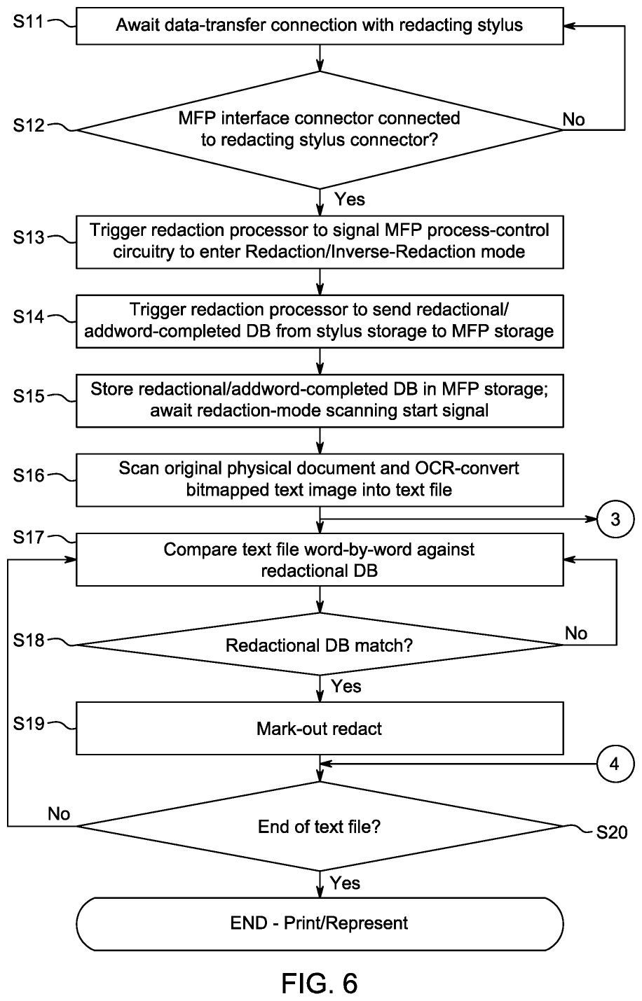

FIG. 6 is a flowchart representing an algorithmic routine that especially configured MFP processing control circuitry 304 of the present disclosure executes. This redacted-document creation routine begins, Step S11, awaiting the above-described data-transfer connection with the redacting stylus. Once the data-transfer connection is established, Step S12, the routine proceeds to Step S13, where the redaction processor 206 in the redacting stylus is triggered to signal the MFP processing control circuitry 304 to go into Redaction Mode. At the same time, in Step S14 the redaction processor 206 is triggered to send the redactional-word database from the redacting-stylus storage to the MFP storage 305. Subsequently, in Step S15 the MFP processing control circuitry 304 stores the redactional-word database in the MFP storage 305, and awaits a signal to start photocopy-scanning by the OCR functionality. Once the MFP processing control circuitry 304 has received the scanning start signal, in Step S16, the MFP scans an original physical document placed on the scanning/copying platen, and the OCR functionality OCR-converts the bitmapped text image into a text file. Next, in Step S17, the MFP processing control circuitry 304 compares the text file word-by-word against the redactional-word database to find matching words, Step S18. If in Step S18 the compared word does not match against any word in the redactional-word database, the process flow reverts to Step S17. On the other hand, if in Step S18 there is a match against the redactional-word database, in Step S19, the MFP processing control circuitry 304 mark-out redacts the matching word or word phrase from the text file. In ensuing step S20, the MFP processing control circuitry 304 determines whether the comparison process has reached the end of the text file. If the comparison process has reached the end of the text file, the routine ends, at which point the MFP, in Step S21, prints out an accordingly redacted photocopy of the text file, or otherwise outputs a redacted copy of the text file for reproduction in a display representation, etc.

### Alternative Embodiments, Etc.

It should be understood that in some embodiments, as an alternative to above-described Steps S15 and S16, after the database is stored in the MFP storage 305, the system may be configured to accept a PDF or image-data copy of the original document, possessed by the user and input or sent by the user to the MFP, in lieu of photocopy-scanning of the original physical document. In such implementations, the thus-received PDF or image-data copy of the original document is OCR-converted into a text file by the MFP's OCR functionality for processing in the subsequent steps of the above-described redacted-document creation routine.

### Metadata Scanning by Redacting Stylus

The redaction processor 206 may also be configured to recognize and process as metadata any previously redacted section or the entirety of the physical original document when the redacting stylus is utilized to scan and OCR-process the document.

An example would be a case where the classified letter in the illustration given above, having once been thus redacted by the redacting stylus of the present disclosure, is again redacted with the redacting stylus. When a blacked-out or otherwise marked out or flagged section is encountered during an operation by the scan-and-OCR processing function of the redacting stylus, metadata may be extracted as indicated in the following.

### Scanned Text

“I knew him when we were in the 371^{st} Radio Research Unit together.”

### JSON-Scripted Database Sample

```
{
    “alreadyRedacted”: “Yes”,
    “RedactOne”: “in the 371^{st} Radio Research Unit”,
}
```

In the example above, the metadata is the word “alreadyRedacted.” The metadata allows the redaction processor 206 to recognize that a redacting process has already been carried out on the phrase just scanned by the redacting stylus, and that the redaction processor 206 is to maintain the redaction.

As described in the foregoing, the presently disclosed technology enables footprint-less marking of redaction targets on a physical original document, and using the unaltered physical original document itself, together with data from the redacting stylus to print out, or otherwise visually represent, an accordingly redacted copy of the physical original document.

### Add Mode (Inverse-Redaction Mode)

The present disclosure contemplates, in addition to the redacting stylus 101 operating with an MFP device 300 as a system in Redaction Mode described in the foregoing, a similar system operating in a text-adding mode that essentially is the inverse of Redaction Mode. This Add Mode, or “Inverse-Redaction Mode,” enables a user to add words, not present in the physical original document, to an OCR-scanned digital copy of the original document that is then printed out, or otherwise output for visual presentation, by an especially configured MFP device 300.

A digital inverse-redacting system according to the present disclosure is made up of the above-described redacting stylus 101 being utilized and operating to create addword-added target strings composing an addword-completed database in the same way that the stylus is utilized and operates to create redaction strings for a redactional-word database, and of an MFP 300 whose processing control circuitry is configured to add word(s) to addword-added target strings constituting the addword-completed database, while being analogous to the above-described redaction strings constituting a redactional-word database for mark-out redacting text from a physical original document.

The redacting-stylus processor 206 may be especially configured by programming information held in the associated memory 207 to operate as an addword processor 206 in Inverse-Redaction Mode, in addition to being configured as a redaction processor 206 operating in Redaction Mode as described above. Operating in Inverse-Redaction Mode, which may be indicated by the sign “Add” or “Add Mode” on the non-emissive display portion 108 of the redacting stylus, the addword processor 206 begins by executing, as an addword-added target string creation routine, essentially the same Steps S1 through S7 of the redaction-string creation routine illustrated by the FIG. 3 flowchart. The only difference is in the labeling: In Step S3, the database file that is created is for setting up the addword-completed database; and in Step S5, the first-/next-recognized word(s) are recorded as a target string, and in Step S6 are displayed as recorded addword targets.

### Algorithm Three

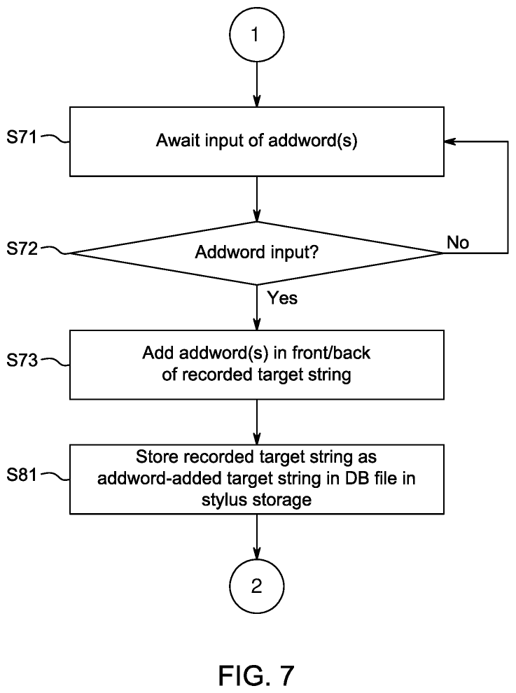

At this point, prior to Step S8 in the routine illustrated by the FIG. 3 flowchart, the switching on of an add-mode function of the digital redacting stylus 101 causes the flow of processes executed by the addword processor 206 to branch to the routine diagrammed by the flowchart of FIG. 7, instead of proceeding to set up a redactional word database. Similar to what was described earlier in explaining how the stylus' main-power switching may be embodied, switching on of the add-mode function may be embodied by a separate mechanical switch, a mechanism within the press-to-scan button 106 itself, similar dual functionality added to, for example, the afore-described scrolling button(s) 109, or a touch-on/touch-off function in implementations in which a touchscreen is employed for the stylus' display.

Referring to FIG. 7, in Step S71, the addword processor 206 awaits input, into the processor's associated memory 207, of an addword(s). The addword(s) may be input, Step S72, into the addword processor 206 on the spot by the redacting stylus' scanning/OCR-processing functionality being used to generate the addword(s) from printed or handwritten physical text, or from digitally displayed text. Alternatively, the addword(s) generated by the redacting stylus' scanning/OCR-processing functionality, or otherwise input into the redacting stylus via touchscreen-display or other external input means, may be stored in the redacting-stylus storage 208 and called up by, for example, a scroll-button(s) or touchscreen-display retrieve/select function. In such alternative implementations, the retrieving/selecting of the addword(s) inputs the addword(s) into the processor's associated memory 207 in Step S72.

In Step S73, the addword processor 206 adds the input addword(s) to either before or after the recorded target string. The add-in position may be instructed via the scroll button(s) 109 or (not illustrated) touchscreen display. In Step S81, the recorded target string to which the addword(s) has been added is stored as an addword-added target string in the redacting-stylus storage 208.

The branch routine ends by going to Step S9 of the FIG. 3 routine. In Step S9, the addword processor 206 determines whether the addword-completed database setup terminate button is on, and if so, proceeds to end the routine, in Step S10, by marking the end of the addword-completed database file. (It will be appreciated that the label on the routine-terminating button whose actuation is awaited in Step S9 mentions “addword” or the like, rather than “redaction,” in reference to the database that is set up.)

The addword-completed database is output to the MFP 300 as described earlier, that is, by plugging the redacting stylus in Add Mode into the MFP slot-holder 301 or otherwise establishing a data-transfer connection between the add-mode stylus 101 and the MFP 300. Establishing the add-mode data-transfer connection triggers the addword processor 206 in the redacting stylus 101 to signal the MFP device 300 to enter into Inverse-Redaction Mode, in which the MFP 300 receives the addword-completed database, and simultaneously triggers the addword processor 206 to send the addword-completed database from the stylus storage 208 to the MFP 300.

The MFP processing control circuitry 304 is configured to load the addword-completed database from the stylus 101 into the MFP storage 305 and put the MFP device 300 into Inverse-Redaction Mode when the data-transfer connection between the stylus 101 and the MFP 300 is set up. In the MFP storage 305, the addword-completed database is available to the MFP scanner's aforedescribed OCR functionality, for producing an addword-modified version of a physical original document via the MFP's photocopying function.

The MFP processing control circuitry 304 may be especially configured to operate in Inverse-Redaction Mode, in addition to being configured to operate in Redaction Mode as described above. Operating in Inverse-Redaction Mode, the MFP processing control circuitry 304 begins by executing, as an addword-added document creation routine, essentially the same Steps S11 through S16 of the redacted-document creation routine illustrated by the FIG. 6 flowchart. The only difference is in the labeling: In Step S13, the addword processor 206 in the stylus 101 is triggered to signal the MFP processing control circuitry 304 to go into Inverse-Redaction Mode; in Step S14 the addword processor 206 is triggered to send the addword-completed database from the stylus storage 208 to the MFP storage 305; and in Step S15 the MFP processing control circuitry 304 stores the addword-completed database in the MFP storage 305, and awaits a signal to start photocopy-scanning (Step S16).

### Algorithm Four

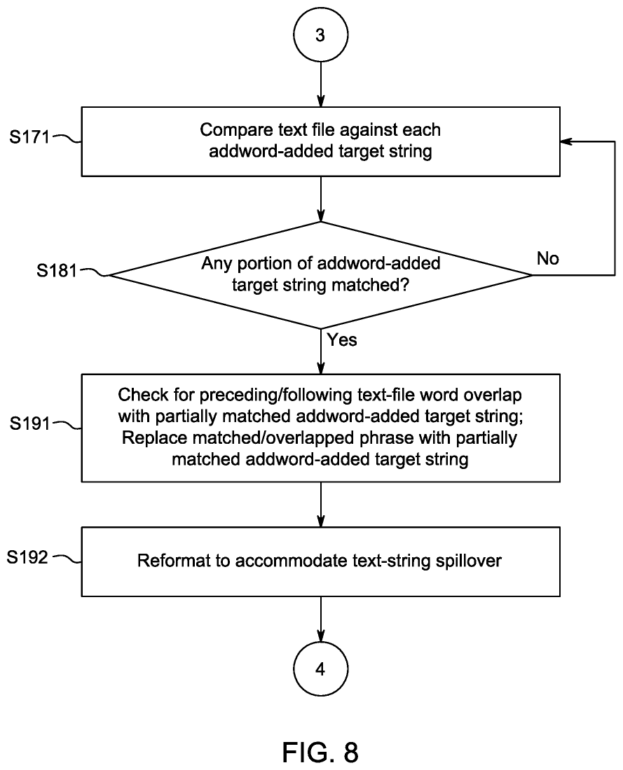

At this point, the MFP processing control circuitry 304 in Inverse-Redaction Mode executes, in lieu of Steps S17 through S19, the branch routine diagrammed by the flowchart of FIG. 8. Referring to FIG. 8, in Step S171 the MFP processing control circuitry 304 compares the text file produced in Step S16 against each addword-added target string in the addword-completed database to find words matching any portion of the addword-added target string, Step S181. If in Step S181 a current text-file word compared against the current addword-added target string does not match any portion of the addword-added target string, the process flow reverts to step S171. If in Step S181 the current text-file word does match some portion of the addword-added target string, then in Step S191, the MFP processing control circuitry 304 checks for any overlap between word(s) preceding/following the current text-file word and the partially matched addword-added target string, and replaces the matched/overlapped phrase in the text file with the entirety of the partially matched addword-added target string. Lastly, in Step S192, the MFP processing control circuitry 304 utilizes the MFP's OCR functionality in conjunction with its page resizing technology to deal with text-string spillover that would otherwise get cut off due to the document-sheet margins. Such spillover accommodation can be accomplished by, for example, shifting the spillover text to the subsequent line and repeating the process until the end of the document that has been photocopy-scanned to create the addword-modified version of the document.

The branch routine ends by going to Step S20 of the FIG. 6 routine. Thus, in ensuing step S20, the MFP processing control circuitry 304 determines whether the comparison process has reached the end of the text file. If the comparison process has reached the end of the text file, the addword-added document creation routine ends. It will be appreciated that above-described Step S192 may follow rather than precede Step S20, in which case the addword-modified version of the text for the entire photocopy-scanned document may be spillover-accommodation processed at once. Upon termination of the addword-added document creation routine the MFP 300, in Step S21, prints out an accordingly addword-modified photocopy of the text file, or otherwise outputs an addword-modified version of the text file for reproduction in a display representation, etc.

Accordingly, with the stylus—MFP system in Add Mode/Inverse-Redaction Mode as described in the foregoing, a user can, for example, utilize the stylus in Add Mode to scan or otherwise input the text “Robert W.” into the stylus' processor-associated memory 207, and then use the addword function to add “Robert W.” before “Rackstraw” in any given place or places in a version of the original physical document that the MFP 300 in Inverse-Redaction Mode creates as a modified photocopy.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A digital redacting stylus comprising:
an elongate casing, opposite ends of which defining tip and butt ends;
a transparent scanning plate provided on the casing tip end;
an imaging module disposed in the casing tip end, having an image sensor, and optics for receiving light reflected from a scanning target and focusing the reflected light onto the image sensor, the image sensor outputting an image data signal representing image information in the scanning target;
a redacting-stylus optical-character-recognition (OCR) processor and associated memory, connected in the casing to the imaging module, the associated memory containing instructions for causing the processor to OCR-process the data signal outputted from the imaging module to convert the data signal into a signal containing text information, and output the text information as words;
a redacting-stylus storage connected to the redacting-stylus redaction processor and associated memory, for storing as a redactional-word database the text information outputted as words from the redacting-stylus redaction processor and associated memory;
a power source in the casing, connected to and powering the imaging module, the redacting-stylus redaction processor and associated memory, and the redacting-stylus storage;
a press-to-scan button connected to the power source; and
an MFP interface connector in the casing butt end, for data-output communicative connection with a multifunction peripheral device.

2. A digital redacting stylus according to claim 1, further comprising an electronic display connected to the redacting-stylus processor, for visually representing the text information in the scanning target as redactional words, wherein the redacting-stylus processor includes display-drive control circuitry.

3. A digital redacting stylus according to claim 2, further comprising either a single forward-/back-scrolling button or dual forward-/back-scrolling buttons connected to the redacting-stylus processor, wherein the redacting-stylus processor includes forward-/back-scrolling control circuitry, for forward-/back-scrolling scrolling through the redactional-word database on the electronic display.

4. A digital redacting stylus according to claim 3, wherein:
the redacting-stylus processor processing the data signal outputted from the imaging module constitutes a record mode of the digital redacting stylus; and
the at least one forward-/back-scrolling button together with the redacting-stylus processor are enabled for switching the digital redacting stylus into and out of the record mode in response to the at least one forward-/back-scrolling button being long-pressed for a predetermined duration.

5. A digital redacting stylus according to claim 4, further comprising a non-emissive display for indicating that the digital redacting stylus is in record mode.

6. A digital redacting stylus according to claim 1, wherein the redacting-stylus processor is configured to put the digital redacting stylus into a redacting-stylus redaction mode in which connection of the MFP interface connector into an MFP device triggers the redacting-stylus processor to signal the MFP device to enter into an MFP redaction mode in which the MFP device receives the redactional-word database, and triggers the redacting-stylus processor to send the redactional-word database from the redacting-stylus storage to the MFP device.

7. A digital redacting stylus according to claim 6, wherein the redacting-stylus processor processing the data signal outputted from the imaging module constitutes a record mode of the digital redacting stylus, the digital redacting stylus further comprising a non-emissive display portion for indicating whether the digital redacting stylus is in recording mode or in redaction mode.

8. A digital redacting stylus according to claim 1, further comprising a scanning illumination source disposed in the casing tip end, for emitting illuminating light through the scanning plate.

9. A digital redacting stylus according to claim 1, wherein the redacting-stylus processor is configured as an addword processor operating to store addwords input into the associated memory, and add the input addwords to either before or after any word in the redactional-word database, thereby creating an addword-completed database.

10. A digital redacting system comprising:
a digital redacting stylus according to claim 1; and
a multifunction peripheral (MFP) device including a scanner, at least one selected from a printer, a display, and a display-representation generating unit, and an I/O port, and having optical-character recognition (OCR) scanning functionality, and further including
a redacting-stylus interface connector for connection with the MFP interface connector in the digital redacting stylus;
an MFP storage; and
MFP processing control circuitry; wherein
the MFP processing control circuitry is configured such as, with the redacting stylus interface connector being connected with the MFP interface connector, to load the redactional-word database from the redacting stylus into the MFP storage and put the MFP device into an MFP redaction mode;
in the MFP redaction mode, the MFP processing control circuitry, via the OCR scanning functionality, OCR-converts any electronic document received either from the scanner or via the I/O port, searches the OCR-converted document for words matching the redactional-word database, mark-out redacts all matching words to produce a mark-out-redacted version of the electronic document, and sends the mark-out-redacted version of the electronic document to the at least one selected from a printer, a display, and a display-representation generating unit; and
the at least one selected from a printer, a display, and a display-representation generating unit either prints out or display-represents the mark-out-redacted version of the electronic document.

11. A digital redacting system according to claim 10, wherein:
the redacting-stylus processor is configured to put the digital redacting stylus into a redacting-stylus redaction mode in which connection of the MFP interface connector into the MFP device triggers the redacting-stylus processor to signal the MFP device to enter into the MFP redaction mode, and triggers the redacting-stylus processor to send the redactional-word database from the redacting-stylus storage to the MFP device; and
the MFP processing control circuitry is further configured such as, with the redacting stylus interface connector being connected with the MFP interface connector, to enter the MFP into the redaction mode on accordingly being signaled by the redacting-stylus processor to enter into the MFP redaction mode.

12. A digital redacting system according to claim 10, wherein the MFP processing control circuitry is further configured such as, with the redacting stylus interface connector being connected with the MFP interface connector, to put the MFP device into an add mode allowing user input, via an operation panel on the MFP, of a word or words before or after any word in the redactional-word database.

13. A digital redacting system according to claim 10, wherein the MFP processing control circuitry is further configured such as, with the redacting stylus interface connector being connected with the MFP interface connector, to put the MFP device into a delete mode in which the MFP processing control circuitry deletes the words in the redactional-word database, to produce a delete-redacted version of the electronic document, and sends the delete-redacted version of the electronic document to the printer.

14. A digital redacting system according to claim 10, wherein the MFP processing control circuitry is further configured such as, with the redacting stylus interface connector being connected with the MFP interface connector, to put the MFP device into a word-counting mode in which the MFP processing control circuitry counts the occurrences of matching words in the OCR-converted electronic document for any user-designated word in the redactional-word database, the user-designated word being designated via an operation panel on the MFP, the processing control circuitry therein further configured to display the counted occurrences of words in the OCR-converted electronic document matching the user-designated word.

15. A digital inverse-redacting system comprising:
a digital redacting stylus according to claim 9; and
a multifunction peripheral (MFP) device including a scanner, at least one selected from a printer, a display, and a display-representation generating unit, and an I/O port, and having optical-character recognition (OCR) scanning functionality, and further including
a redacting-stylus interface connector for connection with the MFP interface connector in the digital redacting stylus;
an MFP storage; and
MFP processing control circuitry; wherein
the MFP processing control circuitry is configured such as, with the redacting stylus interface connector being connected with the MFP interface connector, to load the addword-completed database from the redacting stylus into the MFP storage and put the MFP device into an MFP inverse-redaction mode;
in the MFP inverse-redaction mode, the MFP processing control circuitry, via the OCR scanning functionality, OCR-converts into a text file any electronic document received either from the scanner or via the I/O port,
compares the text file against the addword-completed database to find text-file words matching any portion of the addword-completed database,
when a current text-file word matches some portion of the addword-completed database, checks for any overlap either preceding or following the current text-file word and the matching portion of the addword-completed database, replaces the overlap in the text file with the entirety of the matching portion of the addword-completed database, and sends the addword-added version of the electronic document to the at least one selected from a printer, a display, and a display-representation generating unit; and
the at least one selected from a printer, a display, and a display-representation generating unit either prints out or display-represents the addword-added version of the electronic document.
